(19) United States
(12) Patent Application Publication
(10) Pub. No.: US 2008/0131106 A1
(43) Pub. Date: Jun. 5, 2008

(54) Head-Mounted Mouth-Actuated Camera System

(76) Inventor: Scott Alden Bruce, Cambridge, MA (US)

Correspondence Address: QUICKPATENTS, INC., 32861 CALLE PERFECTO, SUITE A, SAN JUAN CAPISTRANO, CA, 92675, US

(21) Appl. No.: 11/566,562

(22) Filed: Dec. 4, 2006

(51) Int. Cl. G03B 17/08

(52) U.S. Cl. 396/25; 396/420; 396/504

(57) ABSTRACT

A camera mounting system for enabling a person to take pictures or videos hands-free in a wet environment with a water-proof camera is disclosed. The camera is of the type having preferably an electric one or two-position switch actuator. A water-proof actuation cable is connected at one end to a shutter actuation connector that is interconnected to the camera actuator. The other end of the actuation cable terminates in a mouth-actuated shutter control, such as a bite or tongue switch. A head mounting means, such as a helmet, is included for mounting the camera thereon, and has an inside surface, an outside surface, and an aperture therethrough. A longitudinal axis of the aperture is generally either vertical or horizontal when the helmet is worn by an upright person looking forward. As such, the orientation of the person's head can be used to judge the orientation of the camera mounted on such a helmet, the camera being mounted to take normally landscape or portrait oriented photos or videos. A threaded mounting bolt secures the camera to the helmet at a threaded mounting aperture of the camera. The actuation cable further includes a connector and a plug such that the other end of the actuation cable may be selectively separated from the one end of the actuation cable.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to cameras, and more particularly to a novel head-mounted mouth-actuated camera system.

### DISCUSSION OF RELATED ART

In intense water sports, such as white-water kayaking, sea kayaking, surfing, wind surfing, body surfing, sail racing, canoe racing, river rating, rowing, water skiing, wake boarding, jet skiing, skiing, snowboarding, and the like, the sportsman's hands are often occupied holding an oar, ski pole, paddle, tow-rope handle, or other similar sporting article. As such, it is often difficult if not impossible for the sportsman to also be holding a camera and taking either pictures or short movies of the sporting experience. Indeed, at the very times the best pictures might be captured, the sportsman is most likely heavily engaged in actions with his hands that would preclude taking photographs or videos. As such, it would be highly desirable to be able to take pictures at such times without requiring the use of the hands.

Conceptus, a company based in Scottsdale, Ariz., markets two types of mouth-actuated switches, a “bite switch” wherein electrical contacts may be closed by biting on a water-proof rubber actuator, and a “tongue switch” wherein electrical contacts may be closed by depressing a small button with the tongue. Both of these types of switches are used by holding the device between the teeth in the user's mouth. US Patent Application 2004/0164881 to Loun Mok et al. on Aug. 26, 2004 discloses a similar device, as does U.S. Pat. No. 6,222,524 to Salem et al. on Apr. 24, 2001.

While the Conceptus switches are designed for use with cameras, such switches are specifically not designed for use with water-proof cameras in wet or potentially wet environments. No suggestion is made by the Conceptus website at www.conceptusic.com about how to use such switches in a wet environment with a camera, or how to install such switches into pre-existing cameras in a water-proof fashion. Consequently, such switches are designed for use in dry sports such as skydiving, racing, bicycling and the like.

Cameras have been mounted on helmets in the prior art, much of which concerns military or firefighting applications with cameras integrated or fixedly mounted on helmets. However, no camera mounting device has been disclosed that includes a dual mounting means for both portrait and landscape photograph or video orientations. Further, no prior art helmets have been found to have a chin strap that can retain a mouth-actuated switch near the user's mouth, positioned for ready use thereof quickly.

Thus, there is a need for an inexpensive camera mounting system that can be used with waterproof cameras to allow for hands-free operation of the camera in potentially wet environments. Such a needed device would allow the user to take pictures of a selected orientation without using his hands, the camera positioned to photograph or videograph generally the same field of view as the user. Such a needed invention would provide for a water-proof shutter control that is mouth-operated, conveniently positioned, and light-weight. The present invention accomplishes these objectives.

### SUMMARY OF THE INVENTION

The present device is a camera mounting system for enabling a person to take pictures hands-free in a wet environment with a water-proof camera. The camera is of the type having preferably an electric one or two-position switch actuator. A water-proof actuation cable is connected at one end to a shutter actuation connector that is interconnected to the camera actuator. In an embodiment wherein the actuation cable is added to a pre-existing camera, the mechanical button actuator of the camera is removed, the wires of the actuation cable are soldered to the pins of the electric actuator, and a seal means is used to form a water-tight seal with the camera actuator and the cable. In another embodiment, the water-proof camera is made with the one end of the shutter actuation cable built-in complete with a water-proof seal therearound. The other end of the actuation cable terminates in a mouth-actuated shutter control, such as a bite or tongue switch.

A head mounting means, such as a helmet, is included for mounting the camera thereon. The actuation cable is at least long enough to extend from the camera to the person's mouth. The helmet has an inside surface, an outside surface, and an aperture therethrough. A longitudinal axis of the aperture is generally either vertical or horizontal when the helmet is worn by an upright person looking forward. As such, the orientation of the person's head can be used to judge the orientation of the camera mounted on such a helmet, the camera being mounted to take normally landscape or portrait oriented photos and videos. A threaded mounting bolt secures the camera to the helmet at a threaded mounting aperture of the camera. A chin strap is preferably included that retains the helmet on the person's head, and further includes an actuation cable holding means, such as a strap or band, for holding the mouth-actuated shutter control proximate the person's mouth. As such, the person is able to quickly move the shutter control to his mouth without having to grope around for the end of the actuation cable.

Preferably the actuation cable further includes a connector and a plug such that the other end of the actuation cable may be selectively separated from the one end of the actuation cable, so as to change-out the type of shutter control used with the device, for example. Such a connector and plug cooperate so as to provide an electrical connection between the shutter actuation connector and the mouth-actuated shutter control. A water-proof seal means may be included at the interface between the connector and the plug to prevent moisture from entering therebetween, such a water-proof seal means being preferably an elastomeric sealing ring.

The present invention is an inexpensive camera mounting system that can be used with waterproof cameras to allow for hands-free operation of the camera in potentially wet environments. The present device allows the user to take pictures of a selected orientation without using his hands, the camera positioned to photograph generally the same field of view as the user. The present invention provides for a water-proof shutter control that is mouth-operated, light-weight, and conveniently positioned for quick use when needed. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an exploded perspective view of the invention;

FIG. 2 is a perspective view of the invention, illustrating a mouth-actuated shutter control at the end of a water-proof actuation cable;

FIG. 3A is a partially cut-away view of a portion of the invention, illustrating a water-proof camera as mounted to a helmet of the present invention;

FIG. 3B is a partial cut-away view of a shutter actuation connector of the camera, illustrating a plurality of wires electrically connected to electric actuator pins of the actuator, such as by soldering;

FIG. 3C is a partial cut-away view of the shutter actuation connector of the camera, illustrating two wires electrically connected to electric actuator pins of the actuator, such as by soldering;

FIG. 3D is a partial cross-sectional view of the shutter actuation connector of the camera, illustrating a waterproof seal means.

FIG. 4 is a perspective illustration of a person snowboarding with the invention, illustrating the mouth-actuated shutter control as held in the person's mouth;

FIG. 5 is a perspective view of an alternate head mounting means of the invention;

FIG. 6 is a perspective view of the invention as used by a person surfing, illustrating the mouth-actuated shutter control as held by a chin strap proximate the person's mouth;

FIG. 7 is a perspective view of the invention as used by a person kayaking, illustrating the person as temporarily submerged;

FIG. 8 is a partially cut-away exploded perspective view of the invention, illustrating a camera mounting bracket; and

FIG. 9 is a partially cut-away exploded elevational view of the invention, illustrating the camera mounting bracket in more detail.

### DETAILED DESCRIPTION OF THE PREFERRED EMBODIMENT

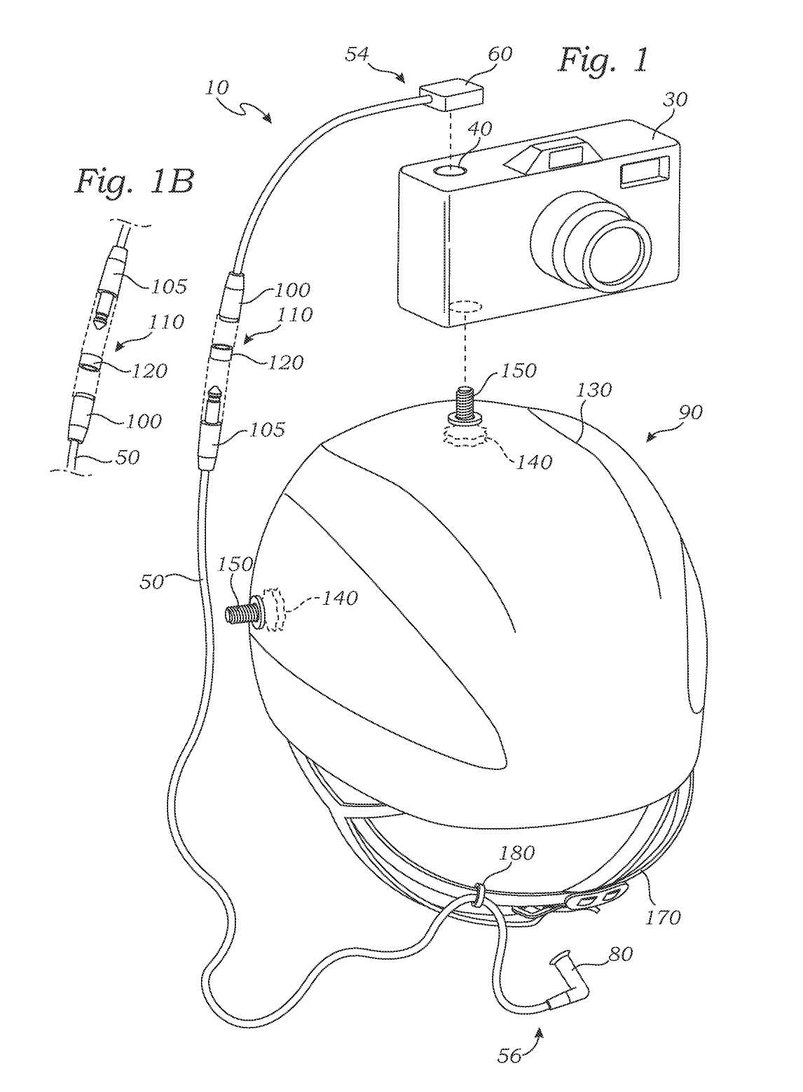

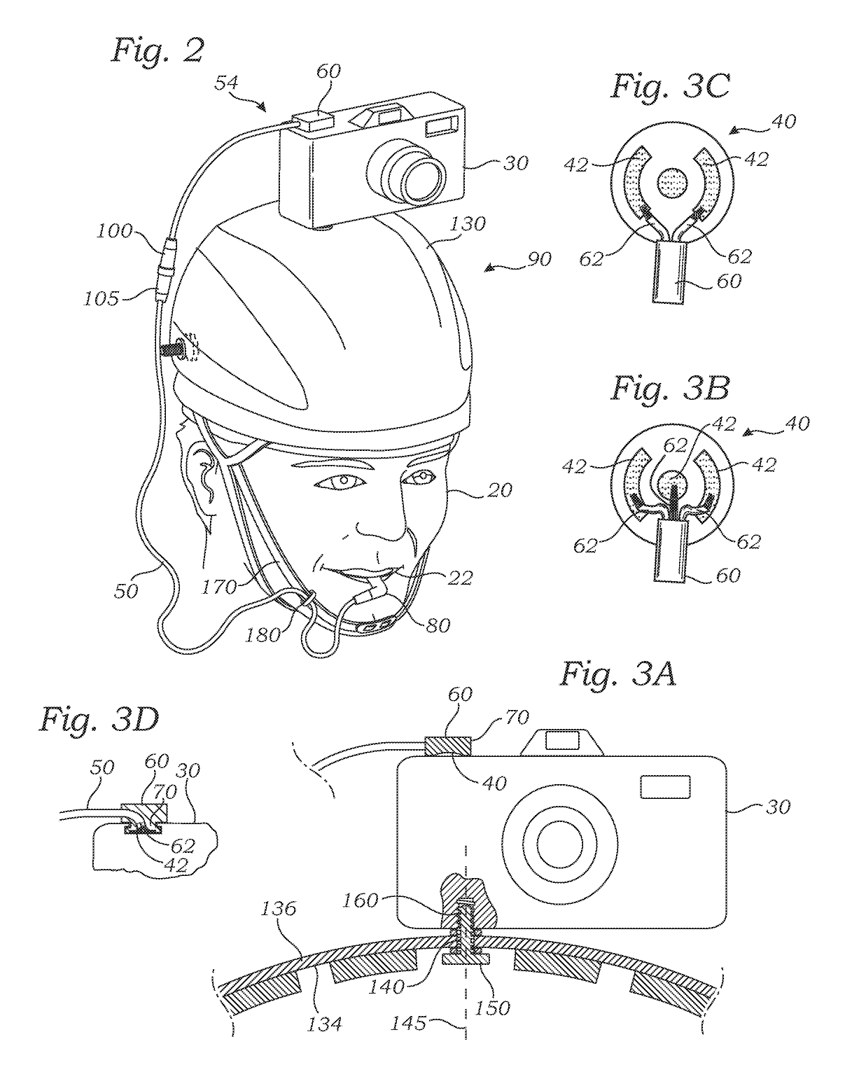

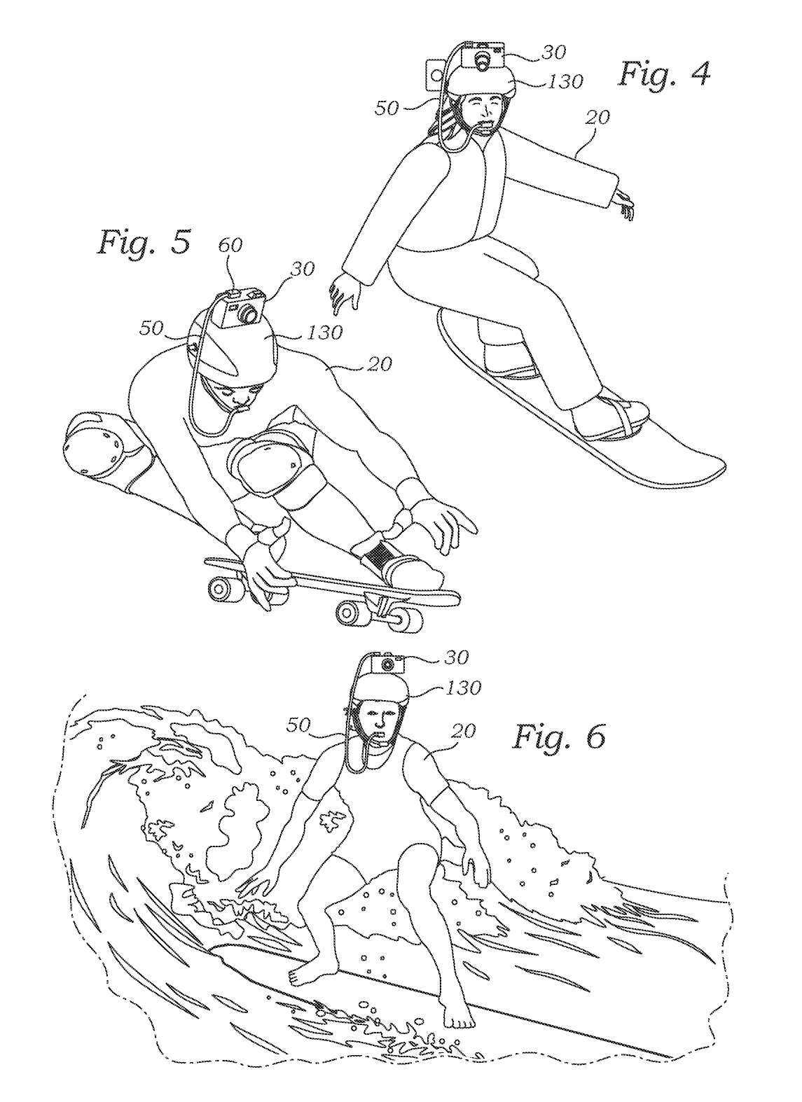

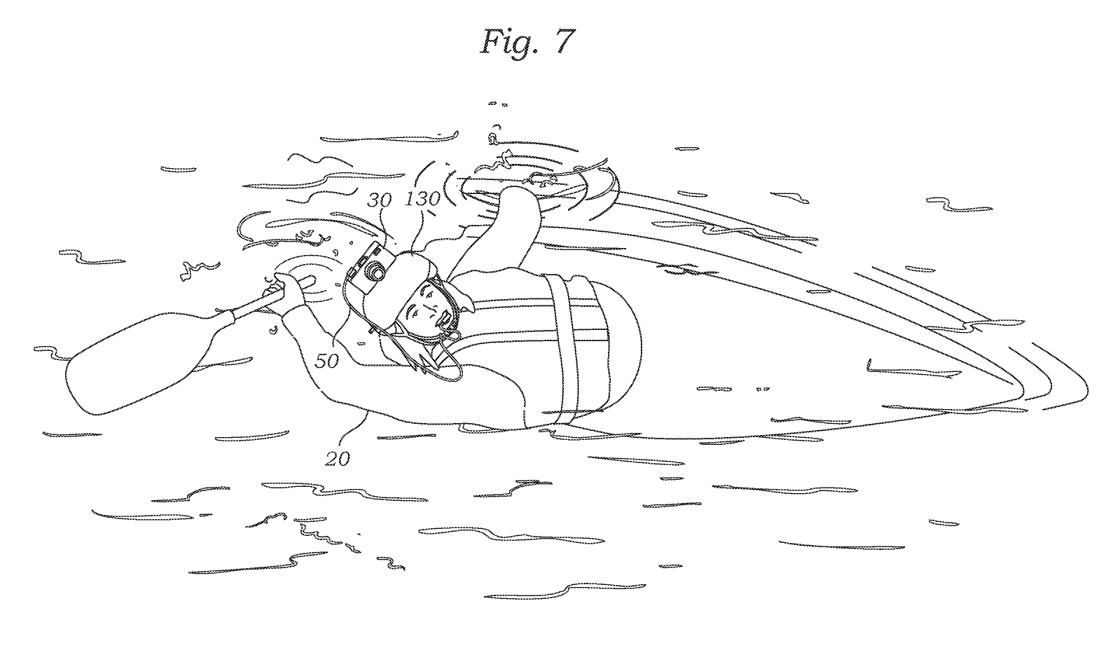

FIGS. 1 and 2 illustrate a camera mounting system 10 for enabling a person 20 to take hands-free pictures in a wet environment with a water-proof camera 30. The camera 30 has an actuator 40, and any of the other elements commonly found on water-proof cameras. The actuator 40 is preferably an electric one or two-position switch that includes two or three electric pins 42 for indicating that the actuator 40 is being depressed either fully or half-way (FIGS. 3B & 3C). The wet environment may be those encountered during intense water sports, such as in white-water kayaking, sea kayaking, surfing, wind surfing, body surfing, sail racing, canoe racing, river rafting, rowing, water skiing, wake boarding, jet skiing, skiing, snowboarding, and the like, and may include periodic submersion in water, as illustrated in FIG. 7.

A water-proof actuation cable 50 is connected at one end 54 to a shutter actuation connector 60 that is interconnected to the camera actuator (FIG. 3A). The shutter actuation connector 60 may be a mechanical actuator for depressing a button-type shutter actuator 40 of the camera 30, or it may be an electrical connection. In the case of an electrical connection, the mechanical button actuator 40 of the camera 30 is removed and a plurality of wires 62 are electrically connected to electric actuator pins 42 of the actuator 40 (FIGS. 3B, 3C), such as by soldering. Once connected, the wires 62 and actuator pins 42 may be encased in a waterproof seal means 70, such as silicon rubber or the like. Such a seal means 70 may also be a molded rubber plug or grommet (not shown), for example. Typical cameras include either two or three actuator pins 42, and a cable 50 with a corresponding number of wires 62 may be used in either case as needed.

The other end 56 of the actuation cable 50 terminates in a mouth-actuated shutter control 80, such as a bite or tongue switch as sold by Conceptus of Scottsdale, Ariz., or the like. Such a bite or tongue switch includes an electrical switch, either a one or two position switch for indicating to the camera a “full” or “partial” depression of the actuator 40. A mechanical plunger (not shown) can also be used in the embodiment that includes a mechanical linkage between the shutter control 80 and the shutter actuation connector 60. Such a mechanical plunger is preferably hand-actuated as opposed to mouth-actuated.

A head mounting means 90, such as a helmet 130, is included for mounting the camera 30 thereon. The actuation cable 50 is at least long enough to extend from the camera 30 to the person's mouth 22 (FIG. 2). The helmet 130 has an inside surface 134, an outside surface 136, and at least one aperture 140 therethrough (FIGS. 1 and 3A). A longitudinal axis 145 of the aperture 140 is generally either vertical or horizontal when the helmet 130 is worn by an upright person looking forward (FIG. 6). As such, the orientation of the person's head can be used to judge the orientation of the camera 30 mounted on such a helmet 130, the camera 30 being mounted to take normally landscape or portrait oriented photos. A threaded mounting bolt 150 secures the camera 30 to the helmet 130 at a threaded mounting aperture 160 of the camera 30, the threaded mounting bolt 150 traversing from the inside surface 134 to the outside surface 136 of the helmet 30 through each aperture 140 thereof (FIG. 3A). In one embodiment of the invention, the helmet 130 includes an aperture 140 with a vertical longitudinal axis 145 and an aperture 140 with a horizontal longitudinal axis 145, so that the camera may be selectively mounted at either aperture 140 depending upon the orientation of the photos or videos desired, either landscape or portrait, respectively.

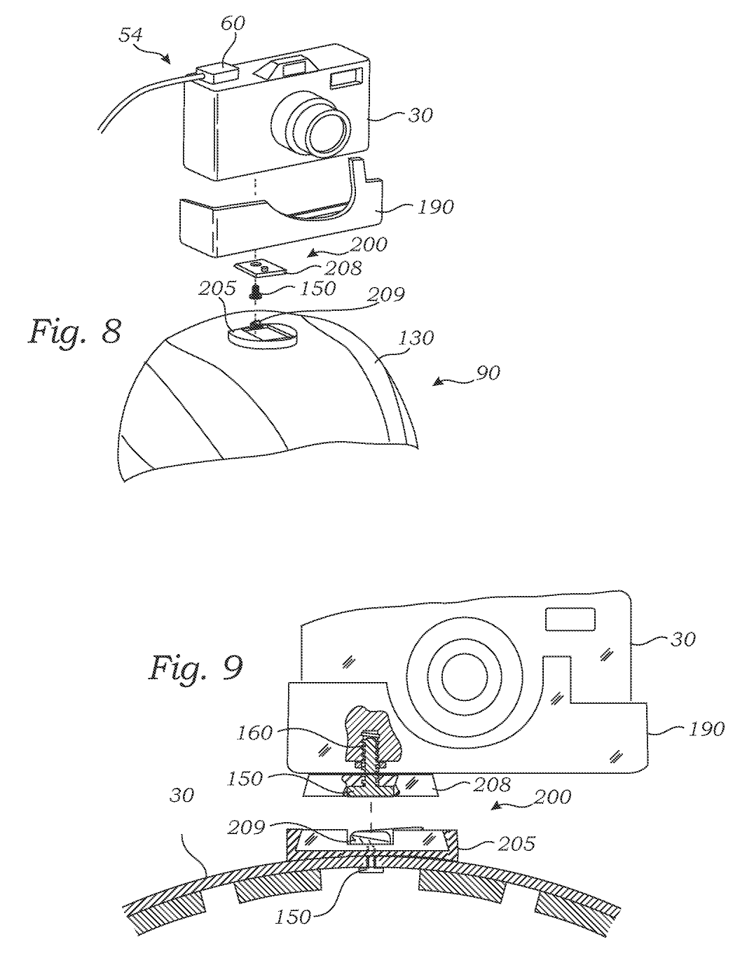

In one embodiment of the invention, the camera 30 is mounted to a camera mounting bracket 190 that prevents rotation of the camera 30 when fixed therein (FIG. 8). The camera mounting bracket 190 is preferably a substantially rigid plastic or foam material, and is itself fixed to a rotationless mounting means 200, such as the Sima SVR QuicKonnect Quick Release Bracket, made by Sima Products Corporation of Oakmont, Pa. Such a rotationless mounting means 200 includes a camera mounting plate 208 fixed to the camera mounting bracket 190 or to the camera 30 with one of the bolts 150, for example, a bracket receiver 205 mounted to the head mounting means 90, such as with one of the bolts 150 and a cam wedge 209 for manually securing the mounting plate 209 to the receiver 205 (FIG. 9). Each bolt 150 may be a quick-release lever-actuated bolt or the like (not shown), to enable rapid removal of the camera 30 and bracket 200 from the head mounting means 90. While one embodiment of a camera mounting bracket 190 has been described, clearly other mounting means may be used, provided that those used with the present invention serve to prevent torque forces from rotating the camera 30 when mounted to the head mounting means 90, such as can occur when being suddenly submerged, for example, or impacted with paddle, limb, boat fore or aft deck, rock, surf board or other water-sports person.

A chin strap 170 is preferably included that retains the helmet 30 on the person's head, and further includes an actuation cable holding means 180 (FIG. 1), such as a strap, cup or band, for holding the mouth-actuated shutter control 80 proximate the person's mouth 22. As such, the person 20 is able to quickly move the shutter control 80 to his mouth 22 without having to grope around for the end 56 of the actuation cable 50. The chin strap 170 may include a chin cup 175, as well as a throat strap 176 (FIG. 1).

Preferably the actuation cable 50 further includes a connector 100 and a plug 105 such that the other end 56 of the actuation cable 50 may be selectively separated from the one end 54 of the actuation cable 50. Such a connector 100 and plug 105 cooperate so as to provide an electrical connection between the shutter actuation connector 60 and the mouth-actuated shutter control 80. Such a connector 100 and plug 105 are preferably used in the embodiment wherein the shutter actuation cable 50 provides an electrical interconnection between the shutter actuation connector 60 and the mouth-actuated shutter control 80, and are preferably common audio connectors and plugs known in the art.

In the embodiment of the invention wherein the actuation cable 50 is an electrical interconnection between the shutter control 80 and actuator 40, at least two electrical wires 62 are required (FIGS. 3C & 3D). With two electrical wires 62, the connector 100 and plug 105 may each be “mono” type two-line devices. It has been found, however, that with two electrical wires 62, the camera 30 must continuously focus and read exposure levels, which reduces battery life. With the preferred three electrical wires 62, the connector 100 and the plug 105 may each be “stereo” type three-line devices. Such three-wire devices may be used when the camera 30 includes auxiliary controls such as exposure control, focal plane control, or the like, as is the case with the Pentax model Optio W10 and the Olympus Stylus 600 and 800 models, for example.

A water-proof seal means 110 may be included at the interface between the connector 100 and the plug 105 to prevent moisture from entering therebetween, such a water-proof seal means 110 being, for example, an elastomeric sealing ring 120 (FIG. 1), liquid-impermeable electrician's tape (not shown), so-called “Liquid Tape” made by Plasti Dip International of Blaine, Minn., or the like. In the embodiment wherein the actuation cable includes a mechanical interconnection, such as a cable, electrical connector 100 and plug 105 are replaced by a suitable mechanical linkage, or eliminated altogether.

While a particular form of the invention has been illustrated and described, it will be apparent that various modifications can be made without departing from the spirit and scope of the invention. For example, the exact placement of the aperture 140 in the helmet 130 may be modified considerably, as can the type of shutter control 80. Further, the camera 30 may be a video camera as opposed to a still picture camera, or a combination of both. Accordingly, it is not intended that the invention be limited, except as by the appended claims.

What is claimed is:

1. A camera mounting system for enabling a person to take pictures in a wet environment with a water-proof camera having at least an actuator, comprising:
a water-proof actuation cable connected at one end to a shutter actuation connector interconnected to the camera actuator, the shutter actuation connecter further including a seal means adapted for forming a water-tight seal with the camera actuator, the actuation cable connected at its other end to a mouth-actuated shutter control, the shutter control connected to the camera actuator through the actuation cable;
a head mounting means for mounting the camera to the head of the person such that the shutter control may be retained in the person's mouth;
whereby the person may actuate the camera shutter by actuating the shutter control with his mouth.

2. The camera mounting system of claim 1 wherein the actuation cable includes, between the shutter actuation connector and the shutter control, a mutually engageable connector and plug, and further including a water-proof seal means for sealing the interface between the connector and plug when the connector and plug are mutually engaged, whereby the one shutter control end of the actuation cable may be selectively separated from the other end of the actuation cable.

3. The camera system of claim 2 wherein the shutter actuation connector is electrically connected to the shutter control through the actuation cable, connector, and plug.

4. The camera system of claim 2 wherein the shutter actuation connector is mechanically connected to the shutter control through the actuation cable, connector, and plug.

5. The camera system of claim 2 wherein the water-proof seal means is an elastomeric sealing ring.

6. The camera system of claim 1 wherein the head mounting means is a helmet having an inside surface, an outside surface, and at least one aperture therethrough, a longitudinal axis of the aperture being either generally vertical or horizontal when the helmet is worn by an upright person looking forward, each aperture retaining therein a mounting bolt for securing the camera to the helmet at a threaded mounting aperture of the camera.

7. The camera system of claim 6 wherein the head mounting means includes exactly two of the apertures, one having a longitudinal axis being generally vertical, and the other having a longitudinal axis being generally horizontal, when the helmet is worn by an upright person looking forward.

8. The camera system of claim 1 wherein the head mounting means further includes a chin strap for selectively retaining the head mounting means on the person's head, the chin strap further including actuation cable holding means for retaining the shutter control proximate the person's mouth.

9. The camera system of claim 8 wherein the head mounting means further includes a throat strap for further retaining the head mounting means on the person's head.

10. A camera system for enabling a person to take pictures in a wet environment, comprising:
a water-proof camera having at least a camera actuator for taking pictures;
a water-proof actuation cable connected at one end to a shutter actuation connector interconnected to the camera actuator, the shutter actuation connecter further including a seal means adapted for forming a water-tight seal with the camera actuator, the actuation cable connected at its other end to a mouth-actuated shutter control, the shutter control connected to the camera actuator through the actuation cable;
a head mounting means for mounting the camera to the head of the person such that the shutter control may be retained in the person's mouth;
whereby the person may actuate the camera shutter by actuating the shutter control with his mouth.

11. The camera mounting system of claim 10 wherein the actuation cable includes, between the shutter actuation connector and the shutter control, a mutually engageable connector and plug, and further including a water-proof seal means for sealing the interface between the connector and plug when the connector and plug are mutually engaged, whereby the one shutter control end of the actuation cable may be selectively separated from the other end of the actuation cable.

12. The camera system of claim 11 wherein the shutter actuation connector is electrically connected to the shutter control through the actuation cable, connector, and plug.

13. The camera system of claim 11 wherein the shutter actuation connector is mechanically connected to the shutter control through the actuation cable, connector, and plug.

14. The camera system of claim 11 wherein the water-proof seal means is an elastomeric sealing ring.

15. The camera system of claim 10 wherein the head mounting means is a helmet having an inside surface, an outside surface, and an aperture therethrough, a longitudinal axis of the aperture being either generally vertical or horizontal when the helmet is worn by an upright person looking forward, the aperture retaining therein a mounting bolt for securing the camera to the helmet at a threaded mounting aperture of the camera.

16. The camera system of claim 15 wherein the head mounting means includes exactly two of the apertures, one having a longitudinal axis being generally vertical, and the other having a longitudinal axis being generally horizontal, when the helmet is worn by an upright person looking forward.

17. The camera system of claim 10 wherein the head mounting means further includes a chin strap for selectively retaining the head mounting means on the person's head, the chin strap further including actuation cable holding means for retaining the shutter control proximate the person's mouth.

18. The camera system of claim 17 wherein the head mounting means further includes a throat strap for further retaining the head mounting means on the person's head.

19. The camera system of claim 6 further including a camera mounting bracket fixed to the camera and selectively fixed to a rotationless mounting means, the rotationless mounting means attached to the head mounting means, whereby the camera is selectively and rotationally fixed to the head mounting means.
